(19) United States
(12) Patent Application Publication
(10) Pub. No.: US 2025/0115215 A1
(43) Pub. Date: Apr. 10, 2025

(54) VEHICULAR EXTERIOR CAMERA WITH LENS CLEANING SYSTEM

(71) Applicant: Magna Mirrors of America, Inc., Holland, MI (US)

(72) Inventor: Bryce A. Hilborn, Grand Rapids, MI (US)

(21) Appl. No.: 18/906,376

(22) Filed: Oct. 4, 2024

Related U.S. Application Data
(60) Provisional application No. 63/589,100, filed on Oct. 10, 2023.

(51) Int. Cl. B60S 1/54; B60R 1/12

(52) U.S. Cl. CPC B60S 1/548; B60R 2001/1253

(57) ABSTRACT

A vehicular vision system includes a camera disposed at structure at a side of a vehicle. The structure extends outward from a side of the vehicle so that the camera views at least rearward of the vehicle. The structure includes an air conduit having an air inlet at a forward portion of the structure and an air outlet at a rearward portion of the structure. The air conduit is adjustable between a closed state and an opened state. As the vehicle moves in a forward direction of travel, and with the air conduit in the closed state, airflow does not flow from the air inlet through the air conduit to the air outlet, and with the air conduit in the opened state, airflow flows through the air inlet and is directed from the air outlet toward a lens of the camera.

### CROSS REFERENCE TO RELATED APPLICATION

The present application claims the filing benefits of U.S. provisional application Ser. No. 63/589,100, filed Oct. 10, 2023, which is hereby incorporated herein by reference in its entirety.

### FIELD OF THE INVENTION

The present invention relates generally to vehicular vision systems that display video images derived from video image data captured by one or more cameras of the vehicle.

### BACKGROUND OF THE INVENTION

It is known to provide an automotive exterior rearview mirror assembly that includes a foldable mirror assembly, such as a powerfold mirror where the mirror head is pivotable via an actuator between a drive or use position and a folded or park position. It is also known to provide a video display at the exterior rearview mirror assembly, such as described in U.S. Pat. No. 7,777,611, which is hereby incorporated herein by reference in its entirety, or to provide a video display at an interior rearview mirror assembly to display sideward and/or rearward images captured by exterior viewing cameras, such as described in U.S. Pat. No. 5,670,935, which is hereby incorporated herein by reference in its entirety.

### SUMMARY OF THE INVENTION

A vehicular vision system or imaging system utilizes one or more cameras (preferably one or more CMOS cameras) to capture image data representative of images exterior of the vehicle, and provides the communication/data signals, including camera data or captured image data, that may be displayed at a display screen that is viewable by the driver of the vehicle, such as when the driver is backing up the vehicle and/or parking the vehicle, and that may be processed and, responsive to such image processing, the system may detect an object at or near the vehicle and in the path of travel of the vehicle, such as when the vehicle is backing up. The vision system may be operable to display a surround view or bird's eye view of the environment at or around or at least partially surrounding the subject or equipped vehicle, and the displayed image may include a displayed image representation of the subject vehicle.

The vehicular vision system may include a camera device disposed at a vehicle equipped with the vehicular vision system. The camera device includes a structure, such as a camera wing or exterior rearview mirror assembly, that supports a camera. The structure and the camera are extended outward from a side of the vehicle so that the camera is positioned with a field of view exterior of the vehicle and the camera views at least partially sideward of the vehicle and rearward and along the side of the vehicle. The structure includes an air conduit having an air inlet at a forward portion of the structure and an air outlet at a rearward portion of the structure. The air conduit is adjustable between a closed state and an opened state. As the vehicle travels in a forward direction of travel, and with the air conduit in the closed state, airflow does not flow from the air inlet through the air conduit to the air outlet. As the vehicle travels in the forward direction of travel, and with the air conduit in the opened state, airflow flows into the air conduit through the air inlet and the airflow is directed from the air outlet toward a lens of the camera to remove contaminants. An actuator is electrically operable to adjust the air conduit between the closed state and the opened state. For example, the actuator may include a motor that axially drives a plunger to move a dam or plug or restrictor relative to the air conduit and adjust airflow through the air conduit.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system that incorporates cameras;

FIG. 2 is a perspective view of a camera wing configured to mount at the vehicle;

FIG. 3 is a perspective view of the camera wing, with a portion of the camera wing removed to show a camera and an actuator of a lens cleaning system accommodated within the camera wing;

FIGS. 4 and 5 are perspective views of the camera wing, with portions of the camera wing removed to show the camera, actuator, and an air conduit of the lens cleaning system;

FIG. 6 is a sectional view of the camera wing, with the lens cleaning system in a closed position to block airflow from entering the air conduit;

FIG. 7 is a sectional view of the camera wing, with the lens cleaning system in an opened position to allow airflow to enter the air conduit;

FIGS. 8-11 are views of the actuator of the lens cleaning system, with FIGS. 8 and 9 including example dimensions of the actuator;

FIGS. 12-15 are views of the actuator and dam of the lens cleaning system, with FIG. 12 including example dimensions of the actuator and dam;

FIG. 16 is a sectional view of the camera wing and actuator with the dam in the closed position;

FIG. 17 is an exploded view of the actuator and dam;

FIGS. 18A, 19A, and 20A are views of the lens cleaning system with the dam in the closed position;

FIGS. 18B, 19B, and 20B are views of the lens cleaning system with the dam in the opened position; and

FIG. 21 is a chart showing example gear ratios for the gear train of the actuator.

### DESCRIPTION OF THE PREFERRED EMBODIMENTS

A vehicle camera monitoring system and/or vision system and/or driver or driving assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and to provide an output to one or more display devices for displaying video images representative of the captured image data. For example, the vision system may provide a rearview display (such as derived from image data captured by one or more rearward viewing cameras at the vehicle) or a top down or bird's eye or surround view display or the like.

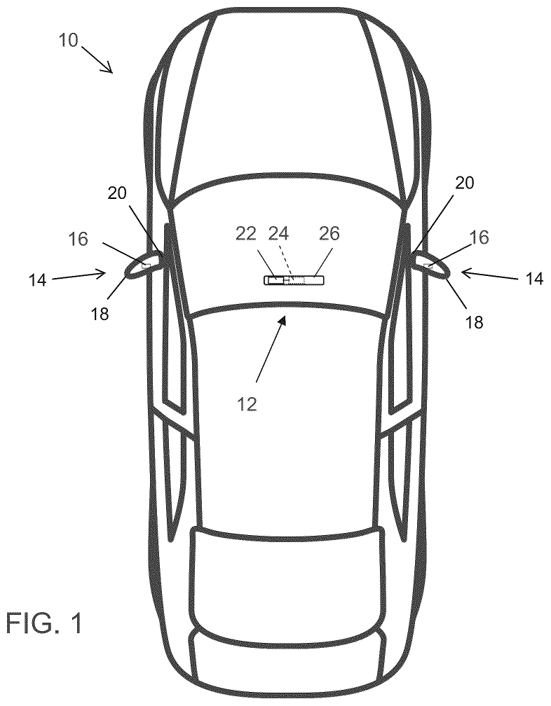

Referring now to the drawings and the illustrative embodiments depicted therein, a vehicle 10 includes an imaging system or vision system 12 that includes multiple exterior viewing cameras, such as wing-mounted camera devices or modules 14 at each side of the vehicle (FIG. 1), such as at or in place of traditional exterior rearview mirror camera locations. The wing-mounted camera devices 14 include cameras 16 disposed on camera wings 18 that may be pivotable relative to a mounting base or arm 20 between a drive position and a park position. At the drive position, the camera wing 18 is extended from the side of the vehicle so that the camera 16 may view sideward and rearward of the vehicle to provide a view sideward and rearward of the vehicle to a driver viewing video images generated from image data captured by the camera 16. At the park position, the camera wing 18 is pivoted in toward the respective side of the vehicle. The wing-mounted camera device 14 may be pivotable between the drive and park positions via operation of an actuator that may be operated responsive to a user input. The wing-mounted camera device may also be manually pivotable between the drive and park positions. The camera wing and wing-mounted camera may utilize characteristics of the systems described in U.S. Publication Nos. US-2023-0211740 and/or US-2022-0258672, which are hereby incorporated herein by reference in their entireties.

Optionally, the sideward and/or rearward facing imaging sensor or camera that has a sideward/rearward field of view at the side of the vehicle may be disposed at a vehicular exterior rearview mirror assembly. The system may also include other cameras, such as surround view cameras (including a rearward viewing or rear backup camera, a forward viewing camera at the front of the vehicle and side surround view cameras at respective sides of the vehicle). The side-mounted camera modules 16 may be part of a camera monitoring system (CMS), which may provide a rearward viewing camera that has a different field of view than the rear backup camera, with the camera (when the module is extended) capturing image data of the respective scene exterior of the vehicle and in the field of view of the respective camera, with each camera having a lens for focusing images at or onto an imaging array or imaging plane or imager of the camera. The system may display video images derived from image data captured by the cameras at a video display screen 24 in the vehicle for viewing by the driver of the vehicle while the driver is operating the vehicle.

The vision system 12 includes a control or electronic control unit (ECU) 22 having electronic circuitry and associated software, with the electronic circuitry including a data processor or image processor that is operable to process image data captured by the cameras, whereby the ECU may detect or determine presence of objects or the like and/or the system may provide video images to the display device 24 of the interior rearview mirror assembly 26 of the vehicle for viewing by the driver of the vehicle and/or to a display device at the center console or stack of the vehicle (and optionally to CMS displays at or near the driver and passenger side A-pillars of the vehicle, such as described in U.S. Publication Nos. US-2018-0134217 and/or US-2014-0285666, which are hereby incorporated herein by reference in their entireties). The data transfer or signal communication from the cameras to the ECU may comprise any suitable data or communication link, such as a vehicle network bus or CAN (Controller Area Network) bus or LIN (Local Interconnect Network) bus or 12C bus or the like of the equipped vehicle.

Exterior cameras, such as those disposed at the exterior rearview mirror assembly or the camera wings 18, are exposed at the exterior of the vehicle and thus are susceptible to collecting dirt, debris, moisture, precipitation and other contaminants at the lens. Because drivers rely on images captured by the camera, a dirty lens obstructs the driver's view and these cameras cannot be safely cleaned manually while the vehicle is in motion. While a spray nozzle may be disposed near the camera for directing pressurized washer fluid at the lens, spraying the camera can leave droplets behind at the lens, further obstructing the view of the driver. Further, while the camera may be hidden from view and/or disposed at the exterior of the vehicle at a position that protects the camera from dirt, debris, moisture and the like, these mounting positions typically prevent the camera from being cleaned. Moreover, mounting the cameras at a protected position is not an option for the camera wings 18.

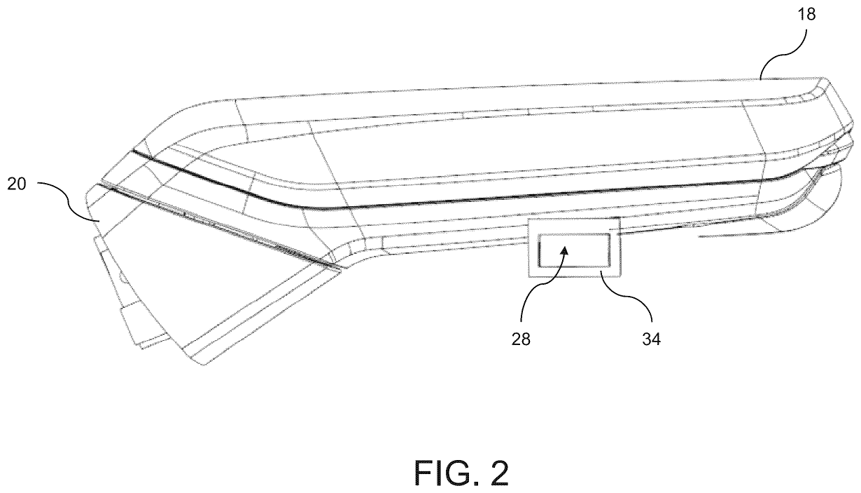

Thus, and as described further below, the camera wing 18 includes an air conduit or wind tunnel 28 that, as the vehicle is in motion, directs airflow toward the camera lens to remove particulates and moisture from the lens (FIG. 2). An actuator assembly 30 is disposed within the camera wing 18 and is electrically operable to open and close the air conduit 28 (i.e., adjust the air conduit 28 between a closed state and an opened state). For example, a plug or dam or restrictor 32 is disposed along the air conduit 28 and the actuator 30 is operable to move the dam 32 relative to the air conduit 28 to block airflow from passing through the air conduit 28 in the closed state and unblock the air conduit 28 so that airflow may enter the air conduit 28 and be directed toward the camera lens in the opened state. Although described herein as relating to a camera at a camera wing, it should be understood that the air conduit may be disposed at an exterior rearview mirror assembly of a vehicle, with the air conduit configured to direct airflow at a camera mounted at or integrated with the exterior rearview mirror assembly, and with the actuator disposed within the mirror head of the mirror assembly.

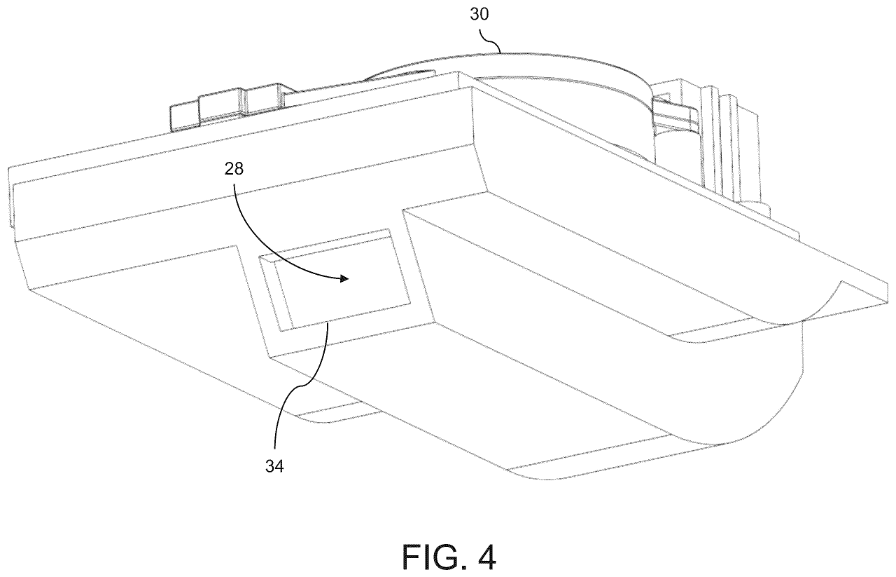

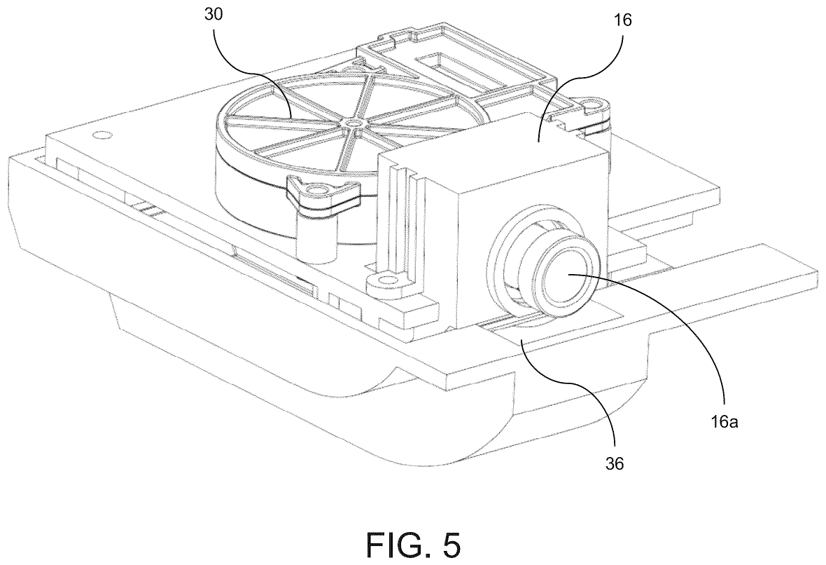

Referring to FIGS. 2-7, the camera wing 18 includes an opening or air inlet 34 to the air conduit 28 that, with the camera wing 18 in the extended position (FIG. 2), faces generally forward toward the front of the vehicle so that airflow may enter the air conduit 28 through the air inlet 34 as the vehicle travels in a forward direction of travel. In the illustrated example, the air inlet 34 comprises a square or rectangular opening or port at the front or forward-facing surface of the camera wing 18. The air inlet 34 and the air conduit 28 may comprise any suitable shape or configuration, such as a circular or oval port with a cylindrical conduit or a square or rectangular or other suitable polygonal port with a correspondingly shaped conduit.

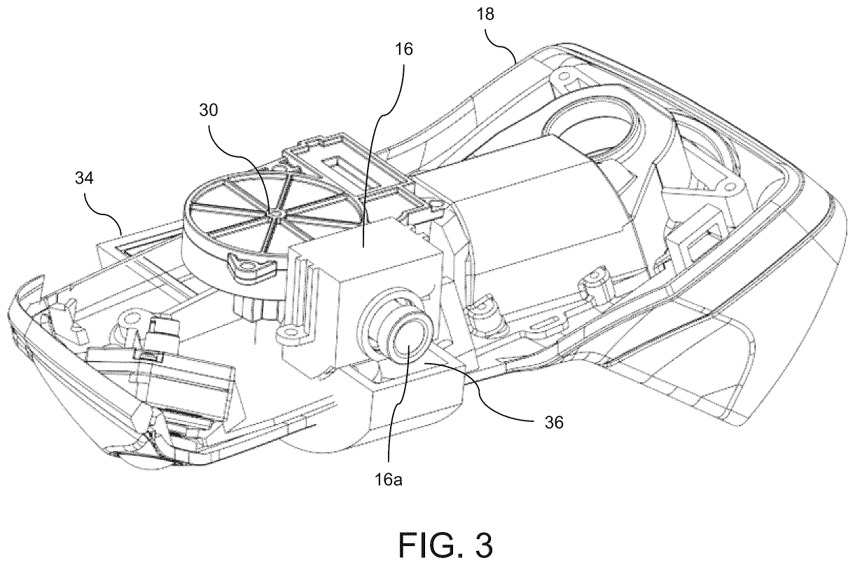

As shown in FIG. 3, the camera 16 is mounted within the camera wing 18 at an opposite side of the camera wing 18 from the air inlet 34 so that, with the camera wing 18 in the extended position, the camera 16 views generally rearward and along the side of the vehicle. The air conduit 28 extends from the air inlet 34 and along a lower portion or region of the camera wing 18 below the camera 16 to an air outlet 36. The air outlet 36 is disposed below the camera 16 and configured to direct airflow upward toward the lens 16a of the camera 16. For example, the air conduit 28 may extend axially along the lower portion of the camera wing 18 from the air inlet 34 and curve upward toward the air outlet 36 to provide a smooth transition from the air inlet 34 to the air outlet 36. The width or cross-dimensional area of the air conduit 28 may narrow from the air inlet 34 toward the air outlet 36 to pressurize and/or increase speed of airflow from the air inlet 34 to the air outlet 36. Optionally, the air inlet 34 may have a sloped or tapered profile toward the air conduit 28 to at least partially pressurize the airflow entering the air conduit 28 and/or the air outlet 36 may have a sloped or tapered profile from the air conduit 28 toward the camera 16 to direct the airflow toward the lens of the camera 16. In other words, the air inlet may have a funnel shape and the air outlet may include a nozzle directed toward the lens of the camera.

Thus, as the vehicle travels along the road in a forward direction of travel, the air inlet 34 is configured to capture airflow, with the airflow guided along the air conduit 28 and directed from the air outlet 36 toward and across the lens 16a of the camera 16. The airflow moves along and across the lens 16a to remove debris and/or moisture from the lens 16a.

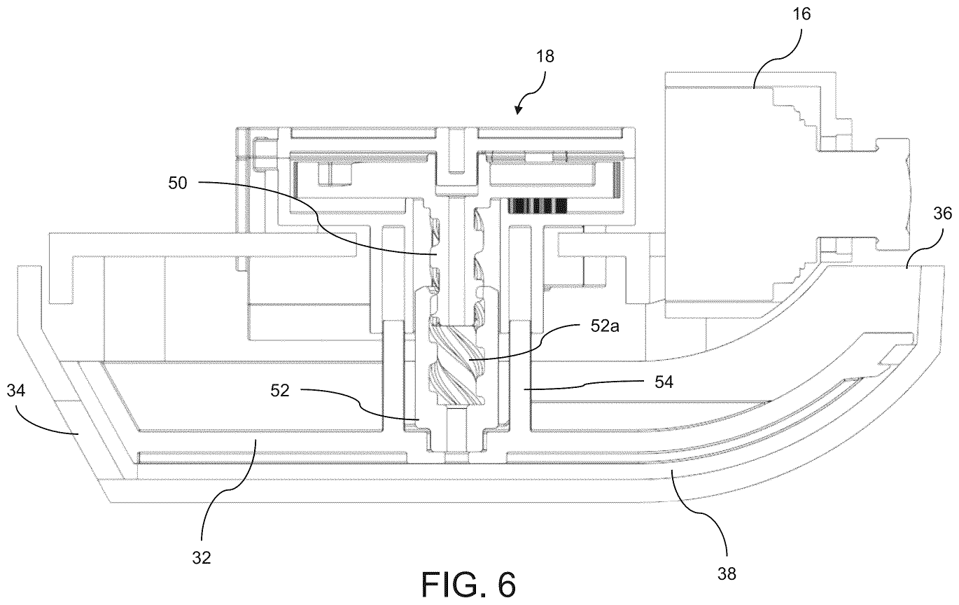

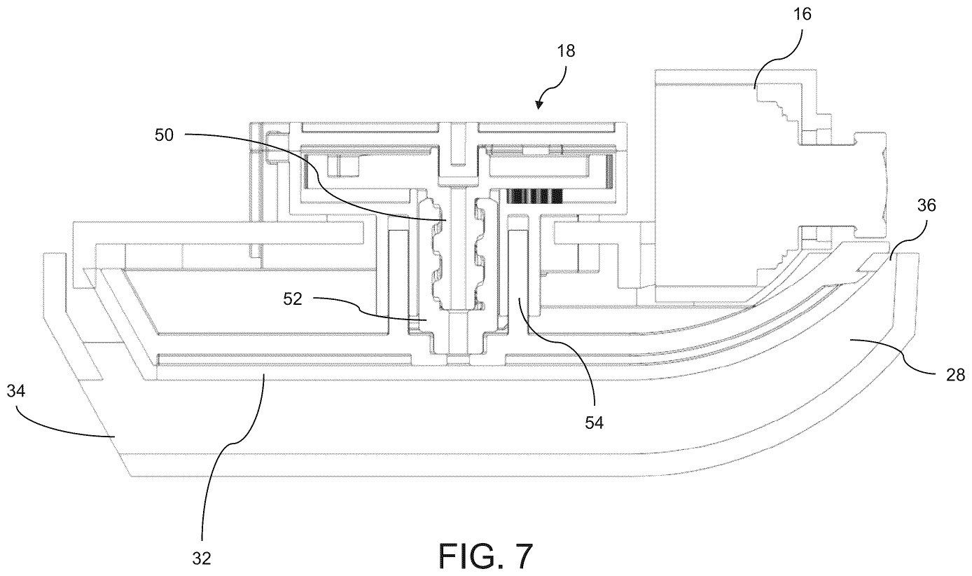

The dam 32 is disposed at least partially along the air conduit 28 and movable between a closed position (FIG. 6), where the dam 32 blocks the flow of airflow from the air inlet 34 toward the air outlet 36, and an opened position (FIG. 7), where the dam 32 is moved relative to the air conduit 28 to allow the flow of airflow from the air inlet 34 toward the air outlet 36. For example, with the dam 32 in the closed position, an end of the dam may substantially fill the air inlet 34 and be flush with or slightly recessed from or slightly extended from an outer surface of the camera wing 18 at the air inlet 34. In the illustrated example, the dam 32 is moved upward within the camera wing 18 to move the end of the dam 32 away from the air inlet 34 and to allow airflow to enter the air conduit 28. With the dam 32 in the opened position, the airflow enters the air inlet 34 and flows along the air conduit 28 toward the air outlet 36. The airflow also flows along a lower surface of the dam 32. Thus, the dam 32 provides a smooth lower surface and a curved or tapered profile to correspond to the profile of the air conduit 28 and to reduce the dimension of the air conduit 28 from the air inlet 34 toward the air outlet 36.

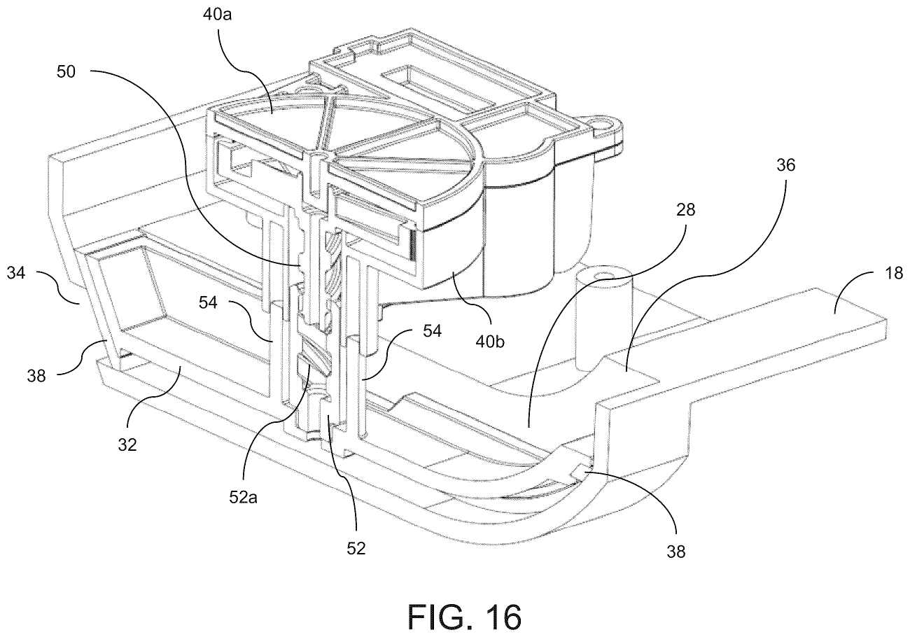

A compressible seal or gasket 38 may be disposed over and along the lower surface of the dam 32 so that, with the dam 32 in the closed position, the gasket 38 is at least partially compressed between the dam 32 and the inner surface of the air conduit 28 to preclude airflow from moving along the air conduit 28. Further, the gasket 38 may be at least partially disposed at the end of the dam 32 disposed at the air inlet 34 to provide a seal between the outer surface of the camera wing 18 and the dam 32 at the air inlet 34. Optionally, portions of the gasket 38 may be disposed at the respective ends of the dam 32 near the air inlet 34 and near the air outlet 36, with an at least partially recessed portion of the dam 32 extending between the portions of the gasket 38 along the surface of the air conduit 28 (FIG. 16). Thus, the portions of the gasket 38 may seal the air inlet 34 and the air outlet 36 while the recessed portion may prevent a suction force from forming between the dam 32 and the surface of the air conduit 28.

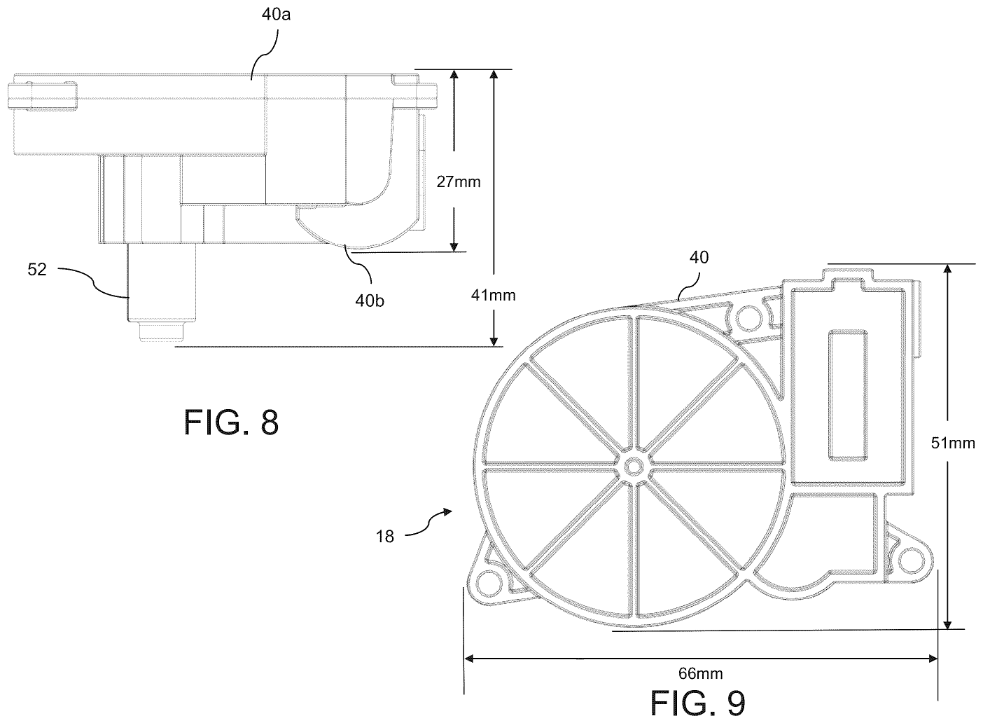

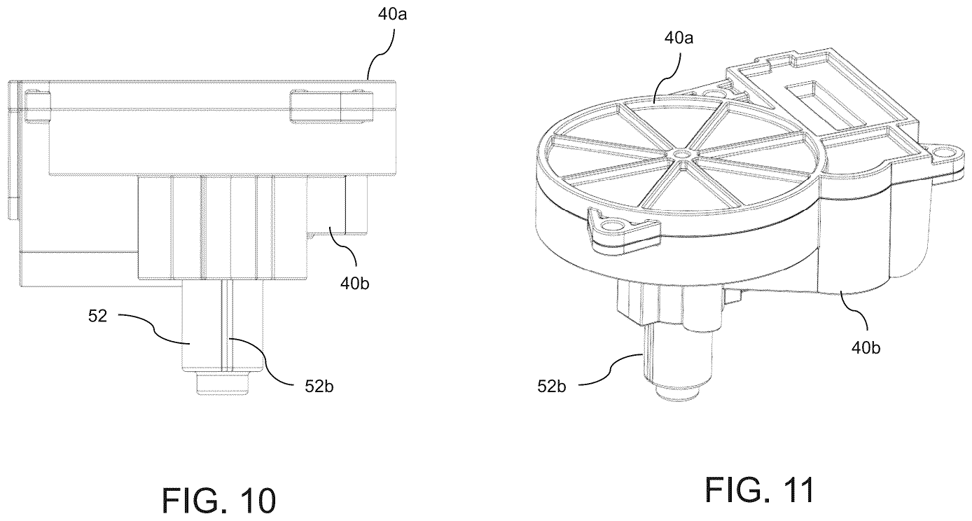

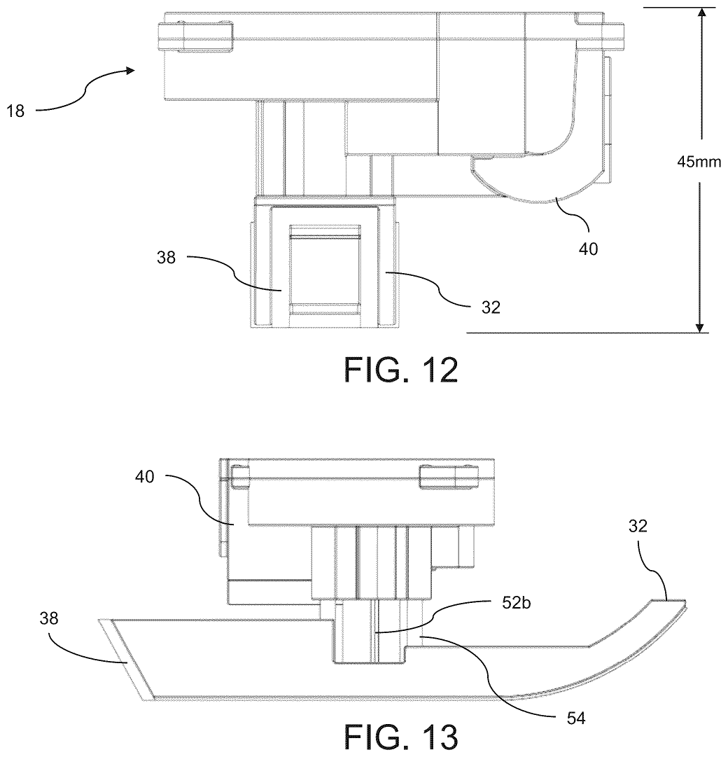

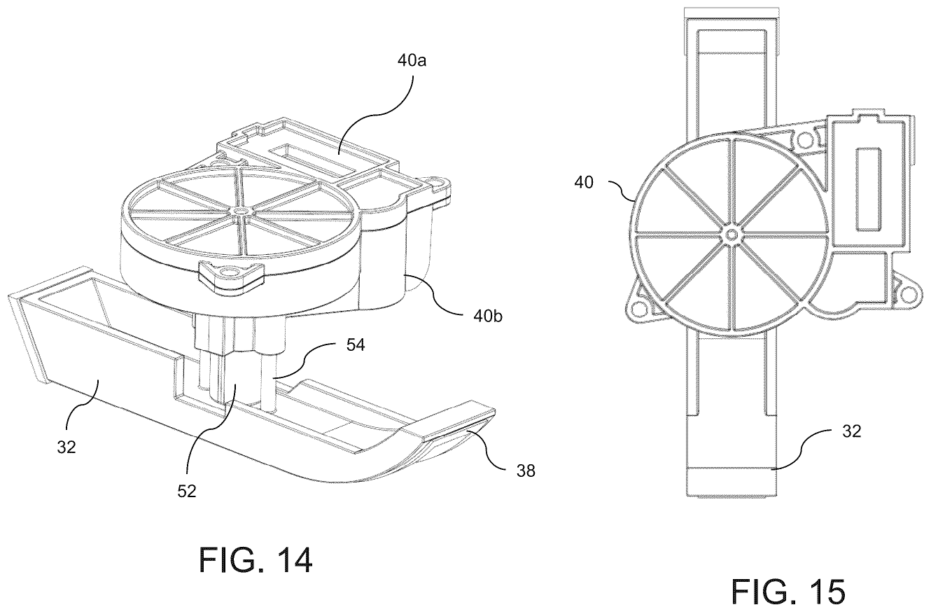

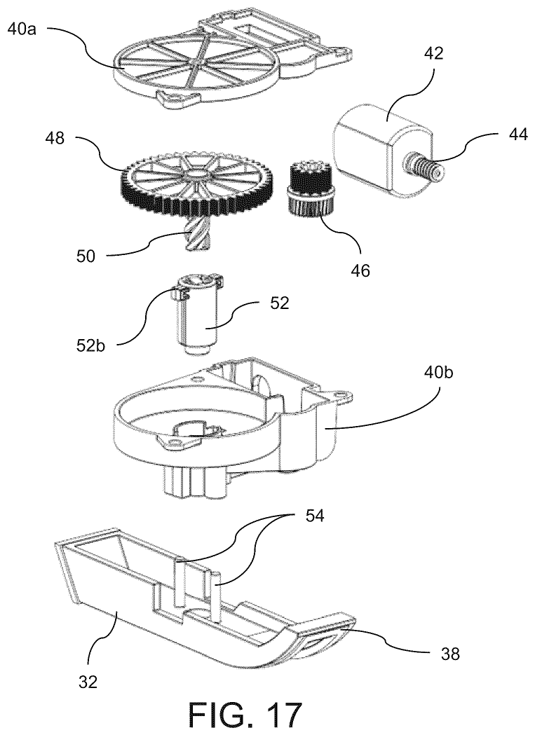

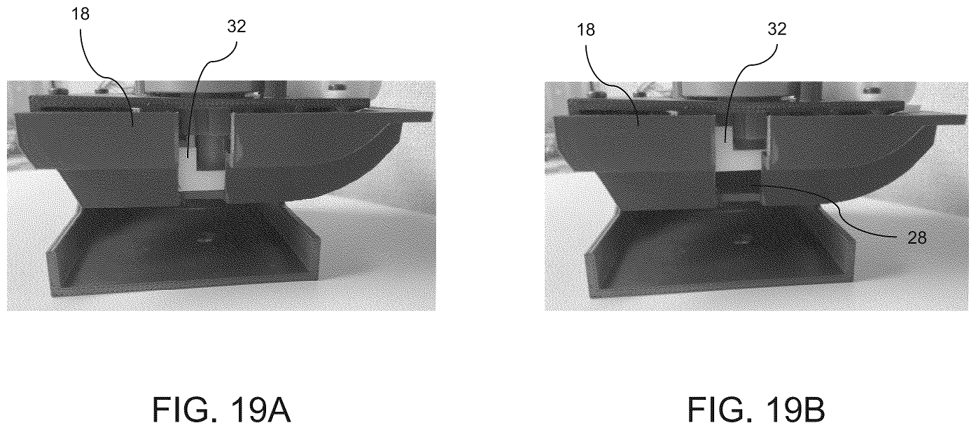

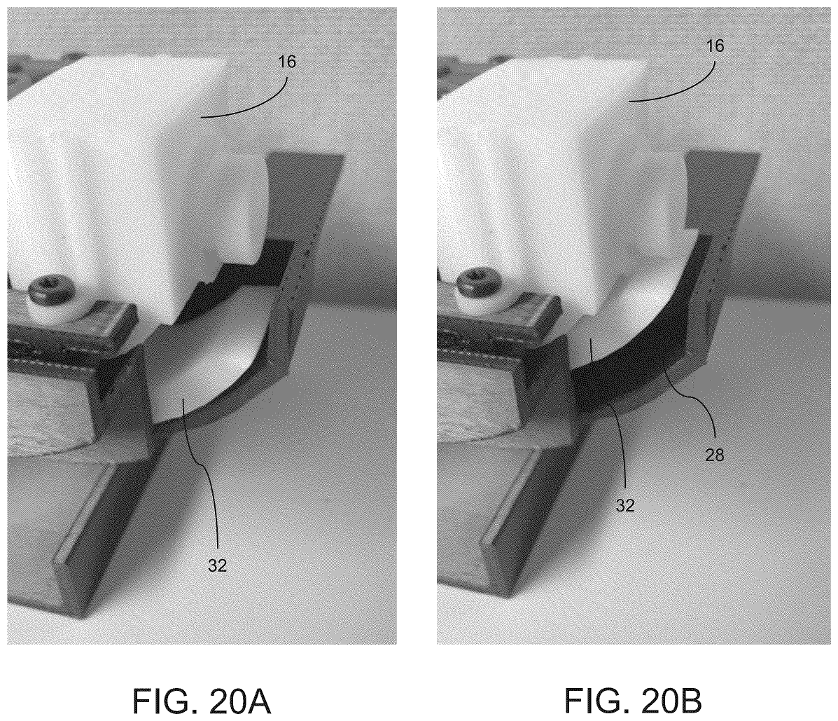

Referring to FIGS. 8-21, the actuator 30 is operable to move the dam 32 between the closed position and the opened position. For example, the dam 32 may be in the closed position when the vehicle is travelling below a threshold speed (e.g., at 25 miles per hour or less, at 15 miles per hour or less, at 10 miles per hour or less, and the like) or during certain weather conditions (e.g., during rainy or snowy weather conditions), and the actuator 30 may be operated to move the dam 32 to the opened position when the vehicle is travelling above the threshold speed or during other weather conditions (e.g., during clear weather conditions or when there is not precipitation at the vehicle). Optionally, such as to reduce wind noise, the dam 32 may be in the closed position and only moved to the opened position episodically (e.g., after vehicle startup and for a period of time after the vehicle has reached a threshold speed), or in response to determination of contaminants at the camera lens 16a (e.g., via processing of captured image data), or in response to a user input (such as when the driver of the vehicle actuates a windshield washer (that sprays water onto the windshield) and/or a forward camera/headlamp washer).

The actuator 30 includes a housing 40, such as an upper housing portion 40a and a lower housing portion 40b that join together, with an electrically operable motor 42 accommodated within the housing 40. When the electrically operable motor 42 is operated, the motor 42 drives a worm gear 44 coupled to the drive shaft of the motor 42. The worm gear 44 in turn drives a combo gear 46 that drives a spur gear 48 coupled to a lead screw 50. The lead screw 50 is in threaded engagement with a threaded chamber 52a of a plunger 52. The plunger 52 extends along a passageway of the lower housing 40b and includes protrusions 52b received along respective recesses of the lower housing 40b to rotationally fix the plunger 52 relative to the lower housing 40b. Thus, as the motor 42 is operated, the lead screw 50 rotates relative to the plunger 52 and the plunger 52 moves axially along the lead screw 50 and along the passageway of the lower housing 40b.

An end of the plunger 52 extends from the passageway of the lower housing 40b and is coupled to the dam 32 to raise and lower the dam 32 relative to the actuator 30 as the plunger 52 is extended and retracted relative to the actuator housing 40. One or more guideposts 54 may extend from the dam 32 and be received along respective channels or passageways of the lower housing portion 40b to rotationally fix the dam 32 relative to the plunger 52 and the actuator housing 40.

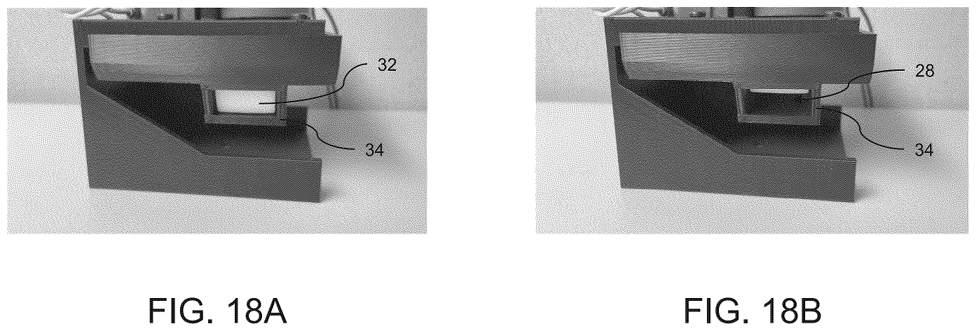

Thus, with the dam 32 in the closed position (FIGS. 18A, 19A, and 20A), the plunger 52 is extended from the actuator housing 40 and along the lead screw 50, and the dam 32 is engaged with the lower surface of the air conduit 28. The gasket 38 may be at least partially compressed and seals the air inlet 34 and/or air outlet 36. When the actuator 30 is operated to move the dam 32 to the opened position (FIGS. 18B, 19B, and 20B), the motor 42 is operated to drive the lead screw 50 and the plunger 52 moves axially along the lead screw 50 toward the actuator housing 40 to lift or raise the dam 32 toward the actuator housing 40.

The actuator 30 provides a compact camera washing solution. FIGS. 8, 9, and 12 include example dimensions for the actuator 30. For example, the actuator housing 40 may have a height when oriented vertically within the camera wing 18 of 27 millimeters. With the plunger 52 in the extended position, the actuator 30 may have a height of 41 millimeters. With the dam 32 coupled to the plunger 52 and the plunger 52 in the extended position, the actuator 30 and dam 32 may have a total height of 45 millimeters. The actuator 30 may have a maximum length of 66 millimeters and a maximum width of 51 millimeters.

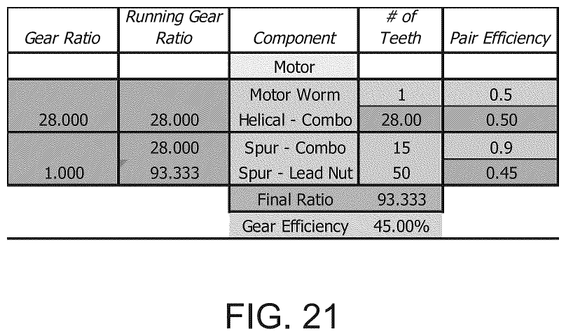

FIG. 21 shows a chart of example gear ratios for the gear train of the actuator 30. As shown, the actuator 30 may have a total gear ratio of 93.33 with a gear efficiency of 45 percent. When operated at 22 degrees Celsius and powered by 13.5 volts, the actuator 30 may move the dam 32 at 17.64 millimeters per second and apply 60 Newton of force. This allows the actuator 30 to move the dam 32 between the opened and closed positions in 0.6 seconds or less. The motor 42 may provide 6.867 milliNetwon-meters of torque and operate at a speed of 8,150 RPM with a current draw of 0.51 amps. The force of the actuator in raising the plunger may be configured to break ice buildup between the end of the dam 32 and the camera wing 18.

Optionally, the actuator 30 may include a clutch element along the gear train between the motor 42 and the plunger 52. Thus, when a force greater than a threshold force is applied at the actuator, such as when the plunger 52 and dam 32 reach an end of the range of travel at the opened position or closed position, or when there is ice buildup between the camera wing 18 and the dam 32, the clutch slips relative to the motor 42 to prevent excess force being applied to the motor 42.

Thus, when the vehicle is moving and/or reaches a threshold speed, the actuator is operated to open or lift up the dam and let air into the wind tunnel. The wind tunnel inlet is on the front of the camera wing or exterior rearview mirror, and the outlet is below the camera lens. The actuator raises the dam to allow air through the wind tunnel and air is directed to the camera lens face. Air exits the wind tunnel at or near the lens face to remove debris. Thus, particulates at the camera lens are blown off using the air that is channeled through the wind tunnel. The cross-sectional area of the wind tunnel decreases as it reaches the end of the wind tunnel to increase the speed of the air across the camera lens. The dam is movable into a closed position to prevent air from flowing constantly. That is, the actuator allows for the dam to be in an open or closed position so that airflow to the camera may be controlled. Constant airflow may cause wind noise and/or throw particulates at the camera lens during inclement weather.

The actuator is configured to move the dam relative to the air conduit between a blocking position and an open position and provides a compact, low-cost apparatus that is effective at clearing obstructions from the field of view of the CMS camera and surround view camera at the camera wing and/or exterior rearview mirror. The system may clean the field of view quickly, such as in less than one second from actuation of the actuator, and overcomes ice buildup. Further, the actuator may be more compact than a glass actuator (such as shorter in a vertical or Z direction) and requires minimal changes to the Class A surface of the mirror assembly. The system may require that the vehicle travel above a threshold speed to direct effective airflow toward the camera lens. The actuator is modular as differently configured camera wings or exterior rearview mirror assemblies may have differently configured air conduits and corresponding dams.

Although shown and described as moving a dam or blocker or plug into and out from a fixed passageway that guides air toward the camera lens, the actuator may function to move the passageway itself from a raised or closed position within the wing housing to a lowered or open position below the wing housing (where the passageway is open to air flow at the front of the passageway below the wing housing). Optionally, a pressurized fluid source may provide pressurized fluid (e.g., water or washer fluid) into the passageway when the passageway is opened to provide a pressurized fluid spray onto the lens. The pressurized fluid source may be actuated by a user input (such as when the driver of the vehicle actuates a windshield washer (that sprays water onto the windshield) and/or a forward camera/headlamp washer) and may only initially inject fluid into the passageway and then shut off while the passageway remains open so that the liquid initially sprays the lens and then the forced air flows through the passageway to dry off and clean the lens.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor of the camera may capture image data for image processing and may comprise, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or pixels or at least three million photosensor elements or pixels or at least five million photosensor elements or pixels arranged in rows and columns. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

Optionally, the vision system may include a display for displaying images captured by one or more of the imaging sensors for viewing by the driver of the vehicle while the driver is normally operating the vehicle. Optionally, for example, the vision system may include a video display device, such as by utilizing aspects of the video display systems described in U.S. Pat. Nos. 5,530,240; 6,329,925; 7,855,755; 7,626,749; 7,581,859; 7,446,650; 7,338,177; 7,274,501; 7,255,451; 7,195,381; 7,184,190; 5,668,663; 5,724,187; 6,690,268; 7,370,983; 7,329,013; 7,308,341; 7,289,037; 7,249,860; 7,004,593; 4,546,551; 5,699,044; 4,953,305; 5,576,687; 5,632,092; 5,708,410; 5,737,226; 5,802,727; 5,878,370; 6,087,953; 6,173,501; 6,222,460; 6,513,252 and/or 6,642,851, and/or U.S. Publication Nos. US-2014-0022390; US-2012-0162427; US-2006-0050018 and/or US-2006-0061008, which are all hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular vision system, the vehicular vision system comprising:
a camera disposed at structure at a side of a vehicle equipped with the vehicular vision system;
wherein the structure extends outward from the side of the vehicle, and wherein, with the structure extended outward from the side of the vehicle, the camera views at least rearward of the vehicle;
wherein the structure comprises an air conduit having an air inlet at a forward portion of the structure and an air outlet at a rearward portion of the structure;
wherein the air conduit is adjustable between a closed state and an opened state;
an actuator that is electrically operable to adjust the air conduit between the closed state and the opened state;
wherein, as the vehicle moves in a forward direction of travel, and with the air conduit in the closed state, airflow does not flow from the air inlet through the air conduit to the air outlet; and
wherein, as the vehicle moves in the forward direction of travel, and with the air conduit in the opened state, airflow flows into the air conduit through the air inlet and the airflow is directed from the air outlet toward a lens of the camera.

2. The vehicular vision system of claim 1, wherein the structure comprises a vehicular camera wing.

3. The vehicular vision system of claim 1, wherein the structure comprises a vehicular exterior rearview mirror assembly.

4. The vehicular vision system of claim 1, wherein the actuator is electrically operable to move a restrictor within the air conduit to adjust the air conduit between the closed state and the opened state.

5. The vehicular vision system of claim 4, wherein, with the air conduit in the closed state, a portion of the restrictor is disposed within the air inlet to prevent airflow from entering the air inlet.

6. The vehicular vision system of claim 5, wherein the portion of the restrictor is flush with an outer surface of the structure surrounding the air inlet.

7. The vehicular vision system of claim 4, wherein the restrictor comprises a compressible sealing element, and wherein, with the air conduit in the closed state, the compressible sealing element is at least partially compressed against an inner surface of the air conduit.

8. The vehicular vision system of claim 4, wherein the actuator comprises an electrically operable motor that, when electrically operated, axially drives a plunger to move the restrictor and adjust the air conduit between the closed state and the opened state.

9. The vehicular vision system of claim 8, wherein the electrically operable motor, when electrically operated, axially drives the plunger along a vertical axis that is perpendicular to a longitudinal axis of the air conduit.

10. The vehicular vision system of claim 1, wherein the air conduit extends at least partially below the camera, and wherein the airflow is directed at least partially upward from the air outlet toward the lens of the camera.

11. The vehicular vision system of claim 1, wherein the vehicular vision system, at least partially in response to determination that the vehicle is moving in the forward direction of travel at a speed greater than a threshold speed, electrically operates the actuator to adjust the air conduit from the closed state to the opened state.

12. The vehicular vision system of claim 1, wherein the vehicular vision system, at least partially in response to determination of presence of contaminants at the lens of the camera, electrically operates the actuator to adjust the air conduit from the closed state to the opened state.

13. The vehicular vision system of claim 1, wherein the vehicular vision system, at least partially in response to determination of absence of contaminants at the lens of the camera, electrically operates the actuator to adjust the air conduit from the opened state to the closed state.

14. A vehicular vision system, the vehicular vision system comprising:
a camera disposed at a vehicular exterior rearview mirror assembly at a side of a vehicle equipped with the vehicular vision system;
wherein the vehicular exterior rearview mirror assembly extends outward from the side of the vehicle, and wherein, with the vehicular exterior rearview mirror assembly extended outward from the side of the vehicle, the camera views at least rearward of the vehicle;
wherein the vehicular exterior rearview mirror assembly comprises an air conduit having an air inlet at a forward portion of the vehicular exterior rearview mirror assembly and an air outlet at a rearward portion of the vehicular exterior rearview mirror assembly;
wherein the air conduit is adjustable between a closed state and an opened state;
an actuator that is electrically operable to adjust the air conduit between the closed state and the opened state;
wherein, as the vehicle moves in a forward direction of travel, and with the air conduit in the closed state, airflow does not flow from the air inlet through the air conduit to the air outlet;
wherein, as the vehicle moves in the forward direction of travel, and with the air conduit in the opened state, airflow flows into the air conduit through the air inlet and the airflow is directed from the air outlet toward a lens of the camera; and
wherein the vehicular vision system, at least partially in response to determination of presence of contaminants at the lens of the camera, electrically operates the actuator to adjust the air conduit from the closed state to the opened state.

15. The vehicular vision system of claim 14, wherein the actuator is electrically operable to move a restrictor within the air conduit to adjust the air conduit between the closed state and the opened state.

16. The vehicular vision system of claim 15, wherein, with the air conduit in the closed state, a portion of the restrictor is disposed within the air inlet to prevent airflow from entering the air inlet.

17. The vehicular vision system of claim 14, wherein the vehicular vision system, at least partially in response to determination of absence of contaminants at the lens of the camera, electrically operates the actuator to adjust the air conduit from the opened state to the closed state.

18. A vehicular vision system, the vehicular vision system comprising:
a camera disposed at a vehicular camera wing at a side of a vehicle equipped with the vehicular vision system;
wherein the vehicular camera wing extends outward from the side of the vehicle, and wherein, with the vehicular camera wing extended outward from the side of the vehicle, the camera views at least rearward of the vehicle;
wherein the vehicular camera wing comprises an air conduit having an air inlet at a forward portion of the vehicular camera wing and an air outlet at a rearward portion of the vehicular camera wing;
wherein the air conduit is adjustable between a closed state and an opened state;
an actuator that is electrically operable to adjust the air conduit between the closed state and the opened state;
wherein, as the vehicle moves in a forward direction of travel, and with the air conduit in the closed state, airflow does not flow from the air inlet through the air conduit to the air outlet;
wherein, as the vehicle moves in the forward direction of travel, and with the air conduit in the opened state, airflow flows into the air conduit through the air inlet and the airflow is directed from the air outlet toward a lens of the camera; and
wherein the vehicular vision system, at least partially in response to determination that the vehicle is moving in the forward direction of travel at a speed greater than a threshold speed, electrically operates the actuator to adjust the air conduit from the closed state to the opened state.

19. The vehicular vision system of claim 18, wherein the actuator is electrically operable to move a restrictor within the air conduit to adjust the air conduit between the closed state and the opened state.

20. The vehicular vision system of claim 19, wherein the actuator comprises an electrically operable motor that, when electrically operated, axially drives a plunger to move the restrictor and adjust the air conduit between the closed state and the opened state.
